(19) United States
(12) Patent Application Publication
(10) Pub. No.: US 2016/0046377 A1
(43) Pub. Date: Feb. 18, 2016

(54) DOUBLE OVEN WIDTH REDUCTION

(71) Applicant: B/E AEROSPACE, INC., Wellington, FL (US)

(72) Inventors: Marcus Michael Cornelis Jaspers, Woerden (NL); Robin Hoegee, Nieuwegein (NL)

(21) Appl. No.: 14/825,816

(22) Filed: Aug. 13, 2015

Related U.S. Application Data
(60) Provisional application No. 62/036,982, filed on Aug. 13, 2014.

(51) Int. Cl. B64D 11/04; A47J 39/02; F24C 15/16; F24C 15/30; F24C 15/08

(52) U.S. Cl. CPC B64D 11/04; F24C 15/30; F24C 15/08; F24C 15/16; A47J 39/02

(57) ABSTRACT

An oven includes a housing having a first compartment enclosed on all sides and a second compartment enclosed on all sides. The first compartment includes a first back wall, a first door opposite the first back wall, the first door operable to open the first compartment; a first top wall; a first bottom wall opposite the first top wall; a first outer wall, and a first inner wall. The second compartment is adjacent the first compartment and includes a second back wall, a second door opposite the second back wall, the second door operable to open the second compartment, a second top wall, a second bottom wall opposite the second top wall, a second outer wall, and a second inner wall. An end first portion of the first inner wall opposite the first back wall is bent to form an acute angle with the first back wall.

### CROSS REFERENCE TO RELATED APPLICATIONS

The present application claims the benefit of U.S. Provisional Application No. 62/036982, filed Aug. 13, 2014, entitled, “Double Oven Width Reduction”, herein incorporated by reference.

### BACKGROUND

Disclosed herein is an oven system for heating food, and, specifically, a double oven system having a reduced distance between cavities of individual ovens thereby reducing an overall width of the oven system.

Prior oven systems for use in vehicles, such as aircraft, that incorporate two oven cavities into a single oven are typically formed of two single ovens inside a single outer cover, and accordingly have a disadvantageous width.

### SUMMARY

Various embodiments and related details are discussed below.

According to an embodiment, an oven system includes a housing having a first compartment enclosed on all sides and a second compartment enclosed on all sides. The first compartment includes a first back wall, a first door opposite the first back wall, the first door operable to open the first compartment; a first top wall; a first bottom wall opposite the first top wall; a first outer wall, and a first inner wall opposite the first outer wall. The second compartment is adjacent the first compartment and includes a second back wall, a second door opposite the second back wall, the second door operable to open the second compartment, a second top wall, a second bottom wall opposite the second top wall, a second outer wall, and a second inner wall opposite the second outer wall. An end first portion of the first inner wall opposite the first back wall is constructed to create a front-portion space.

According to another embodiment, an oven system includes a housing defining a first compartment enclosed on all sides and a second compartment enclosed on all sides. The housing includes a back wall, a first outer wall intersecting the back wall, a second outer wall intersecting the back wall and provided opposite the first outer wall, and an inner wall dividing the back wall into a first back wall portion and a second back wall portion, the inner wall being provided at a position between the first outer wall and the second outer wall. The first compartment of the oven is enclosed by the first back wall portion, the first outer wall, the inner wall, and a first door on a front side of the first compartment opposite the first back wall portion, the first door operable to open the first compartment. The second compartment of the oven is enclosed by the second back wall portion, the second outer wall, the inner wall, and a second door on a front side of the second compartment, the second door operable to open the second compartment. An end first portion of the inner wall that is opposite the back wall includes a first portion and a second portion constructed to form a space towards a front end of the compartments closest to the doors.

While the exemplary embodiments described herein are presented in the context of an oven system for an aircraft galley, these embodiments are exemplary only and are not to be considered limiting. The embodiments of the apparatus are not limited to ovens for use in an aircraft galley. For example, embodiments of the apparatus may be adapted for a refrigerator, freezer, and other food storage and cooking devices. Various embodiments may thus be used in any vehicle, including aircraft, spacecraft, ships, buses, trains, recreational vehicles, trucks, automobiles, and the like. Embodiments of the apparatus may also be used in homes, offices, hotels, factories, warehouses, garages, and other buildings where it may be desirable to heat food with steam. In general, the embodiments may be used in any location or application in which heating food is desired.

### BRIEF DESCRIPTION OF THE DRAWINGS

Various embodiments are illustrated in the drawings and following discussion.

FIG. 1 is a front view of an oven according to an embodiment, shown with open doors to reveal the oven compartments.

FIG. 2 is a detail pictorial top view of an oven, according to an embodiment.

FIG. 3 is a detail pictorial front view of an oven, according to an embodiment.

FIG. 4 is a detail pictorial top view showing bent sections of an oven, according to an embodiment.

FIG. 5 is a detail pictorial front view of the oven shown in FIG. 4.

FIG. 6 is a pictorial front view of a conventional double oven.

FIG. 7 is a pictorial top view of a conventional double oven.

FIG. 8A is a pictorial top view of an oven, according to an embodiment.

FIG. 8B is a pictorial top view of an oven, according to another embodiment.

FIG. 9 is a perspective front view according to an embodiment illustrating shelving aspects.

### DETAILED DESCRIPTION

According to embodiments, the width of an oven system can be reduced to thereby save valuable work space. This is particularly valuable in aerospace where it is desirable to reduce the size and weight of appliances.

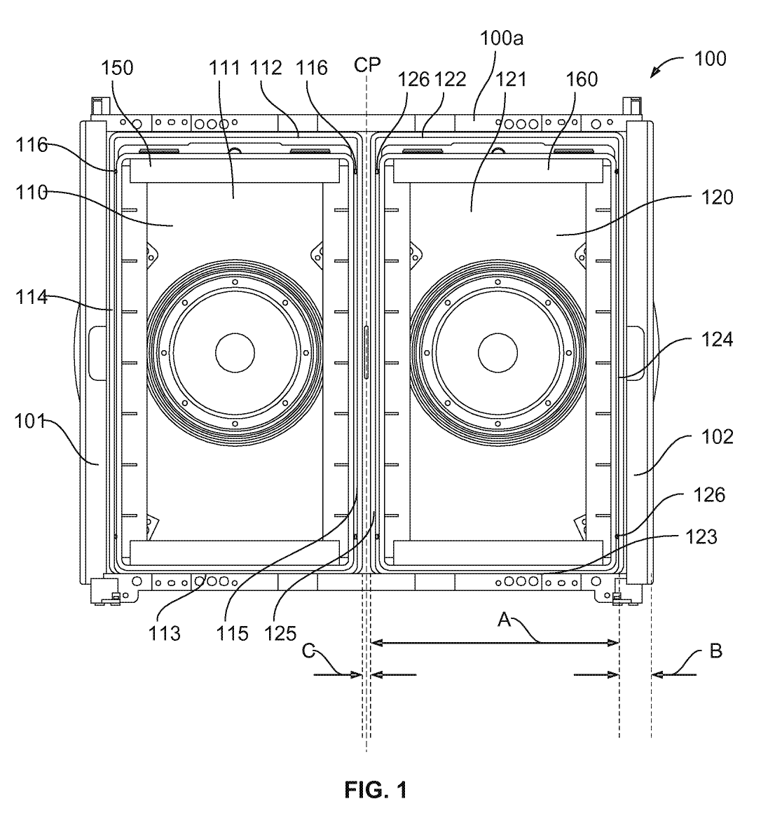

FIG. 1 is a front view of an oven system 100 for heating meals that are provided in meal carriers 150, 160, according to an embodiment. The oven system 100 is shown with a housing 100a and both a first door 101 and a second door 102 in an open position to show the inside of the first compartment 110 and the second compartment 120. The first compartment 110 and the second compartment 120 are enclosed on all sides. The first compartment 110 is defined by the first door 101 on a front part of the oven system 100, a first back wall 111 opposite the first door 101, a first top wall 112, a first bottom wall 113 opposite the first top wall 112, a first outer wall 114, and a first inner wall 115 opposite the first outer wall 114. The second compartment 120 is defined by the second door 102 on the front part of the oven system 100, a second back wall 121 opposite the second door 102, a second top wall 122, a second bottom wall 123 opposite the second top wall 122, a second outer wall 124, and a second inner wall 125 opposite the second outer wall 124.

The first compartment 110 may be provided with a first push through 116 to center a meal carrier 150 in the first compartment 110. The second compartment 120 may also be provided with a second push through 126 to center the meal carrier 160 in the second compartment 120. The first push through 116 may comprise notches that are formed in the first outer wall 114 and the first inner wall 115. The second push through 126 may comprise notches that are formed in the second outer wall 124 and the second inner wall 125. The first and second push throughs 116, 126 may take the form of other structures that are capable of centering meal carriers 150, 160 in the first and second compartments 110, 120 as known by those having ordinary skill in the art.

As shown in FIG. 1, the width of oven system 100 is affected primarily by three factors. The width (A) of the cavity or compartment 110, 120 itself is a first factor. In the oven system 100 of FIG. 1, the first compartment 110 and the second compartment 120 are depicted as having similar widths. The width (A) can be based upon, for example, the width of the meal carrier 150, 160 that is to be placed within the oven compartment. A second factor is the thickness (B) of the door 101, 102 and the ability to fully open the door 101, 102 and make the entire compartment 110, 120 accessible. A third factor is the distance (C) between the cavities or compartments 110, 120. This distance (C) is mainly driven by the distance needed to fit the hardware to seal off the compartments 110, 120, the seals themselves, and the hardware to structurally support the seals.

According to the oven system 100 shown in FIG. 1, the oven width is decreased by reducing the distance between the compartments 110, 120. The push throughs 116, 126 that are provided on the inside of the first and second compartments 110, 120, respectively, allow for bending of the inside edges of the cavities to make room for the door hardware, without decreasing the width of the compartments 110, 120 to get the meal carrier 150, 160 out. Only the edges of the first inner wall 115 and the second inner wall 125 need to be adapted (i.e., only on the sides of the compartments 110, 120 that are next to each other). Bending the edges of the first inner wall 115 and the second inner wall 125 creates additional space to fit the door hardware, while allowing the first compartment 110 and the second compartment 120 to be positioned close to one another. A center plane CP is shown that divides the oven system 100 in half or at least is positioned to be parallel to the first 115 and second 125 inner walls and equidistant from each.

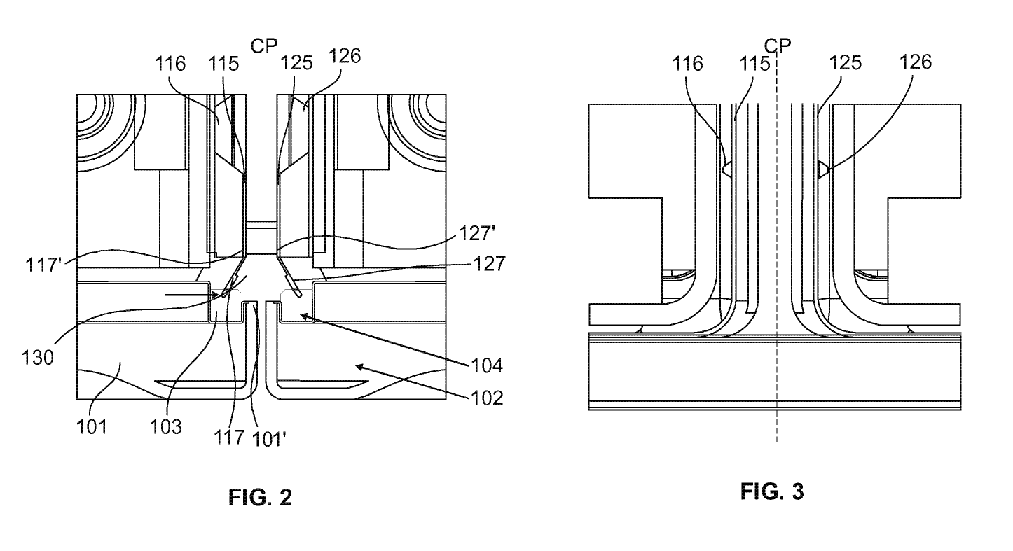

FIG. 2 is a detail pictorial top view of the oven system 100. The first door 101 and second door 102 are shown in a closed position, with the first door seal 103 provided between the first door 101 and the first inner wall 115 and the second door seal 104 provided between the second door 102 and the second inner wall 125. The first door has an edge portion 101′ that extends closer to the center plane CP than the door seal 103. As depicted in FIG. 2, an end portion 117 of the first inner wall 115 and an end portion 127 of the second inner wall 125 are bent, i.e., angled or rounded away from a center plane between the two inner walls in a frontmost portion, to provide space 130 for the first and second seals 103, 104 and hardware of the first and second doors 101, 102. The door seal 103 interacts with the end portion 117 of the first inner wall 115. Corresponding structure exists for the second compartment 120 as well.

FIG. 3 is a detail pictorial front view of the oven system 100, depicting the space between the first inner wall 115 and the second inner wall 125.

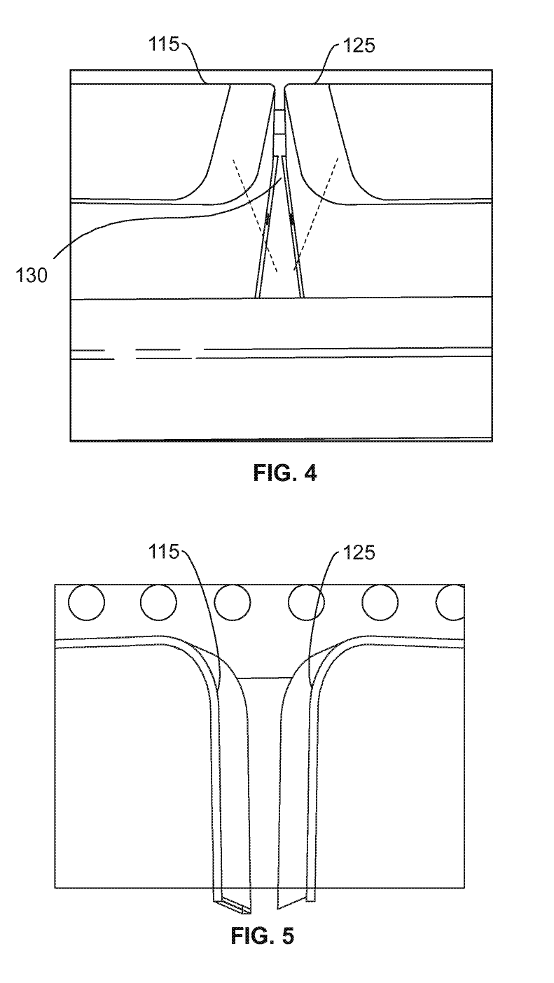

FIG. 4 and FIG. 5 are diagrams illustrating a top view and a front view, respectively, showing bent sections of the oven system 100. As previously described, the first inner wall 115 and the second inner wall 125 have respective bent/angled/rounded portions 117, 127, respectively, to provide space 130 for mounting and sealing hardware 103, 104 (shown in FIG. 2), such that the first and second compartments 110, 120 can be positioned closer together.

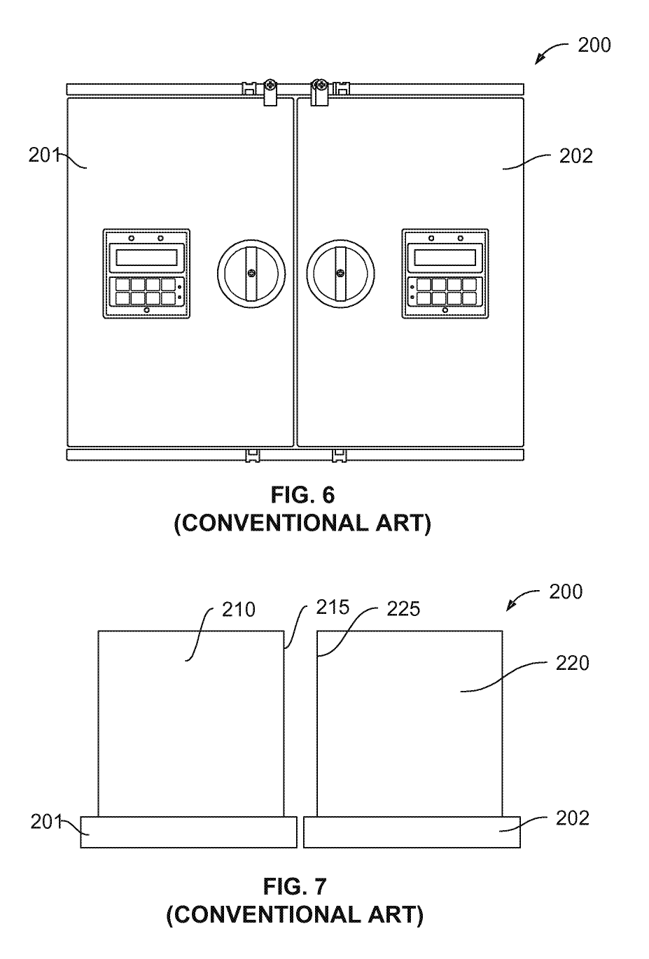

FIG. 6 is a pictorial front view of a conventional double oven 200. The double oven 200 is shown with a first door 201 and a second door 202 in a closed position. Conventional double ovens, as schematically shown in FIG. 7, are the combination of two ovens into a single housing without further modifications to the doors, seals, and underlying structures of the individual ovens.

As shown in FIG. 7, the conventional double oven 200 comprises a first compartment 210 and a second compartment 220. A first inner wall 215 of the first compartment 210 is a straight wall. Similarly, a second inner wall 225 of the second compartment 220 is a straight wall. Thus, to properly mount and seal the first door 201 and the second door 202 to the respective compartments 210, 220, the first compartment 210 must be positioned a sufficient distance away from the second compartment 220.

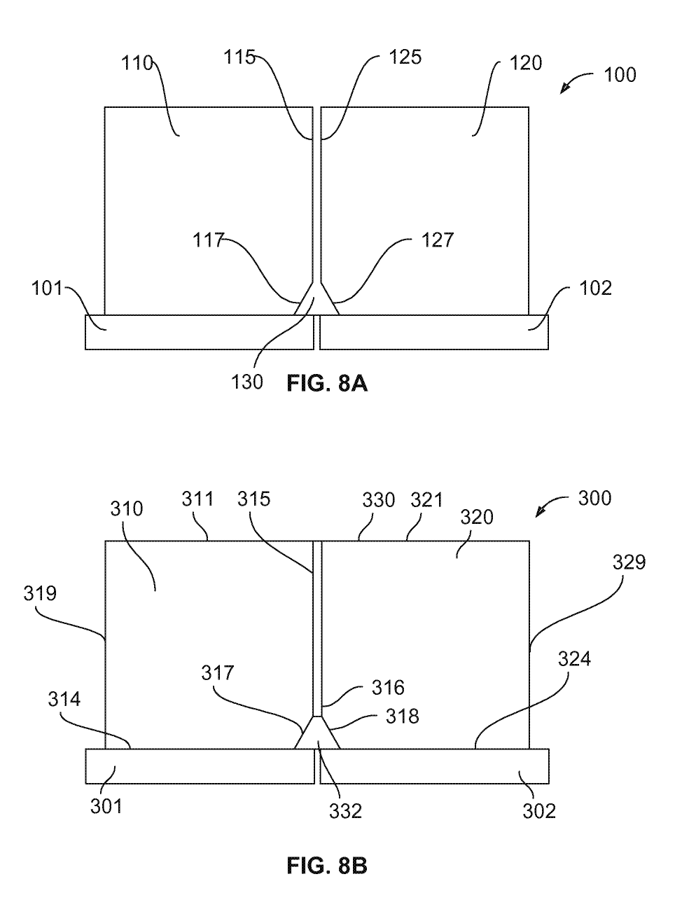

On the other hand, as shown in the schematic overview of an embodiment in FIG. 8A, the first inner wall 115 and the second inner wall 125 are provided with end portions 117, 127, respectively, that are constructed to provide space for sealing and mounting the first and second doors 101, 102. Accordingly, the compartments 110, 120 in oven system 100 are positioned closer to one another when compared to the compartments 220, 220 in the conventional oven 200.

According to the schematic overview of FIG. 8B, the first compartment 310 and the second compartment 320 in oven 300 are separated by a common inner wall 315. The inner wall 315 divides the back wall 330 into a first back portion 311 and a second back portion 321. A first outer wall 319 and second outer wall 329 opposite the first outer wall 219 are provided. At an end portion 316 of the inner wall 315, a first connecting portion 317 and a second connecting portion 318 are provided. The first connecting portion 317 and the second connecting portion 318 are constructed to provide a space 332 for the hardware required by the first and second doors 301, 302. In an embodiment, the first and second connecting portions 317, 318 extend away from a center line between the first and second compartments 310, 320 as the connecting portions 317, 318 extend towards a front portion of the compartments 310, 320. As illustrated in the embodiment shown in FIGS. 8A and 8B, this is formed by the connecting portions 317, 318 being acute angled regions with respect to the second back portion 321. However, these could be rounded (concave or convex), stepped (including a single 90° angle), notched, or even form a complex shape, such as one suited to accommodate door hardware. The front portion of the compartments 310, 320 is narrower than the rear portion of the compartments 310, 320, with the narrowness coming from the front portion being offset in a direction away from a center line dividing the two compartments to create the space 332.

In an embodiment, the first 110 and second 120 compartments are constructed to be mirror images of one another. However, these two do not have to be entirely symmetrical and can comprise differing sizes while retaining the above described structure (e.g., the widths of the two can differ).

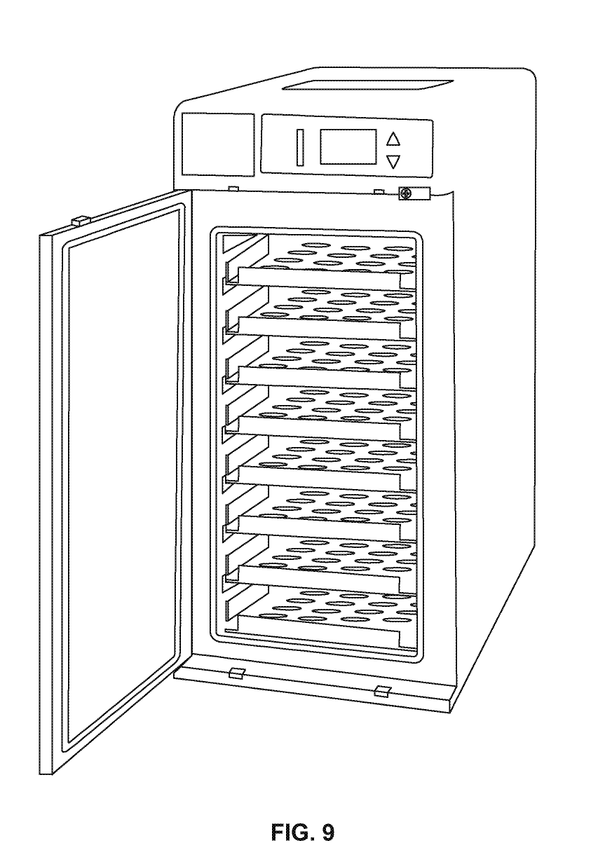

FIG. 9 is a perspective front view according to an embodiment that illustrates various relationships between component features and shelving aspects.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

TABLE OF REFERENCE CHARACTERS

| | |
|---|---|
| 100 | oven system |
| 100a | housing |
| 101 | first door |
| 101′ | first door edge portion |
| 102 | second door |
| 103 | first door seal |
| 104 | second door seal |
| 110 | first compartment |
| 120 | second compartment |
| 111 | first back wall |
| 112 | first top wall |
| 113 | first bottom wall |
| 114 | first outer wall |
| 115 | first inner wall |
| 116 | first push through |
| 117 | end first portion of first inner wall; bent/angled/rounded portion |
| 117′ | second portion of the first inner wall |
| 120 | second compartment |
| 121 | second back wall |
| 122 | second top wall |
| 123 | second bottom wall |
| 124 | second outer wall |
| 125 | second inner wall |
| 126 | second push through |
| 127 | end first portion of second inner wall; bent/angled/rounded portion |
| 127′ | second portion of the second inner wall |
| 130 | space formed by end first portion(s) |
| 150 | meal carrier |
| 160 | meal carrier |
| 200 | conventional double oven |
| 201 | first door |
| 202 | second door |
| 210 | first compartment |
| 215 | first inner wall |
| 220 | second compartment |
| 225 | second inner wall |
| 300 | oven |
| 301 | first door |
| 302 | second door |
| 310 | first compartment |
| 311 | first back wall portion |
| 315 | inner wall |
| 316 | end portion of inner wall |
| 317 | first connecting portion |
| 318 | second connecting portion |
| 319 | first outer wall |
| 320 | second compartment |
| 321 | second back wall portion |
| 329 | second outer wall |
| 332 | space |
| CP | center plane |

What is claimed is:

1. An oven system comprising:
a housing;
a first compartment disposed inside the housing and enclosed on all sides, the first compartment comprising:
a first back wall;
a first door opposite the first back wall, the first door operable to open the first compartment;
a first top wall;
a first bottom wall opposite the first top wall;
a first outer wall ; and
a first inner wall opposite the first outer wall;
a second compartment enclosed on all sides, the second compartment disposed inside the housing and adjacent the first compartment, the second compartment comprising:
a second back wall;
a second door opposite the second back wall, the second door operable to open the second compartment;
a second top wall;
a second bottom wall opposite the second top wall;
a second outer wall; and
a second inner wall opposite the second outer wall,
wherein an end first portion of the first inner wall opposite the first back wall is constructed such that a front of the first compartment is narrower than a rear of the first compartment.

2. The oven system of claim 1, wherein the end first portion of the first inner wall is bent to form an acute angle with the first back wall.

3. The oven system of claim 2, wherein a second portion of the first inner wall that extends substantially perpendicularly to the first back wall is abutting a second portion of the second inner wall that extends substantially perpendicularly to the second back wall.

4. The oven system of claim 1, further comprising:
a first push through provided in the first compartment for centering meals to be heated in the first compartment; and
a second push through provided in the second compartment for centering meals to be heated in the second compartment,
wherein:
the first push through comprises a plurality of first inner wall notches formed in an inner surface of the first inner wall and a plurality of first outer wall notches formed in an inner surface of the first outer wall, and
the second push through comprises a plurality of second inner wall notches formed in an inner surface of the second inner wall and a plurality of second outer wall notches formed in an inner surface of the second outer wall.

5. The oven system of claim 1, wherein the end first portion of the second inner wall is bent to form an acute angle with the second back wall.

6. The oven system of claim 1, wherein a first door seal of the first door contacts the end first portion of the first inner wall to seal the first compartment.

7. The oven system of claim 6, wherein:
a center plane is defined as being parallel to and centrally located between the first inner wall and the second inner wall; and
a portion of the first door seal is closer to the center plane than an end of the end first portion of the inner wall.

8. The oven system of claim 7, wherein a first door edge portion is closer to the center plane than the first door seal.

9. The oven system of claim 1, wherein the end first portion of the second inner wall is curved or stepped.

10. An oven system comprising:
a housing defining a first compartment enclosed on all sides and a second compartment enclosed on all sides, the housing comprising:
a back wall;
a first outer wall intersecting the back wall;
a second outer wall intersecting the back wall and provided opposite the first outer wall; and
an inner wall dividing the back wall into a first back wall portion and a second back wall portion, the inner wall provided at a position between the first outer wall and the second outer wall;
wherein:
the first compartment is enclosed by the first back wall portion, the first outer wall, the inner wall, and a first door on a front side of the first compartment opposite the first back wall portion, the first door operable to open the first compartment,
the second compartment is enclosed by the second back wall portion, the second outer wall, the inner wall, and a second door on a front side of the second compartment, the second door operable to open the second compartment, and
an end first portion of the inner wall opposite the back wall comprises a first bend portion forming an acute angle with the first back wall portion and a second bend portion forming an acute angle with the second back wall portion.
